(19) United States
(12) Patent Application Publication
(10) Pub. No.: US 2024/0007879 A1
(43) Pub. Date: Jan. 4, 2024

(54) MAC CE BASED BEAM FAILURE RECOVERY IN MULTIPLE TRP SCENARIO

(71) Applicant: Lenovo (Beijing) Limited, Beijing (CN)

(72) Inventors: Bingchao Liu, Beijing (CN); Chenxi Zhu, Fairfax, VA (US); Lianhai Wu, Beijing (CN); Wei Ling, Beijing (CN); Yi Zhang, Beijing (CN)

(73) Assignee: Lenovo (Beijing) Limited, Beijing (CN)

(21) Appl. No.: 18/255,317

(22) PCT Filed: Dec. 4, 2020
(86) PCT No.: PCT/CN2020/133788

§ 371 Date: May 31, 2023

(51) Int. Cl. H04W 24/04; H04W 74/08

(52) U.S. Cl. CPC H04W 24/04; H04W 74/0833

(57) ABSTRACT

Methods and apparatuses for MAC CE based beam failure recovery in multi-TRP scenario are disclosed. In one embodiment, a method comprises transmitting a capability report on supporting configuration of multiple BFD RS sets for a serving cell; and receiving a configuration including at least two NBI (new beam identification) RS sets and two BFI (beam failure indication) counters for the serving cell.

### FIELD

The subject matter disclosed herein generally relates to wireless communications, and more particularly relates to methods and apparatuses for MAC CE based beam failure recovery in multi-TRP scenario.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), beam failure recovery (BFR), transmission reception point (TRP), Special Cell (SpCell), Primary Cell (PCell), Secondary Cell (SCell), Primary Secondary Cell (PSCell), reference signal (RS), Non-Zero Power (NZP), channel state information reference signal (CSI-RS), synchronization signal block (SSB), beam failure detection (BFD), beam failure recovery request (BFRQ), Downlink control information (DCI), multiple TRP (multi-TRP or M-TRP), multiple DCI (multi-DCI), Master Cell Group (MCG), Secondary Cell Group (SCG), Medium Access Control (MAC), MAC control element (MAC CE), Physical Uplink Control Channel (PUCCH), beam failure indication (BFI), new beam identification (NBI), contention free random access (CFRA), contention based random access (CBRA), uplink shared channel (UL-SCH), Protocol Data Unit (PDU), Control Resource Set (CORESET).

Traditional beam failure recovery (BFR) procedure for single-TRP scenario was specified for SpCell in NR Release 15 and further enhanced for SCell in NR Release 16. A set of periodic RSs, e.g. NZP CSI-RS resources, are configured for the UE for a cell for beam failure detection (BFD), and another set of periodic RS, e.g. SSB resources, are configured for the UE for the cell for new beam identification. The UE will send a beam failure recovery request (BFRQ) to the gNB when the radio link qualities of all configured RSs for BFD are lower than a configured threshold. Single-DCI based and multi-DCI based multiple TRP DL transmission are specified in NR Release 16 on SpCell as well as SCell. The UE is required to maintain two different TRP-UE links in a cell. However, the traditional BFR procedure only targets single TRP scenario. Enhancement on the BFR procedure in multi-TRP scenario is necessary.

SpCell refers to “Special Cell”. For Dual Connectivity operation, the term “Special Cell” refers to the PCell of the MCG (Master Cell Group) or the PSCell of the SCG (Secondary Cell Group) depending on whether the MAC entity is associated to the MCG or the SCG, respectively. Otherwise, the term “Special Cell” refers to the PCell. A “Special Cell” supports PUCCH transmission and contention-based random access, and is always activated.

This invention discloses methods and apparatuses for BFR procedure in multiple TRP scenario.

### BRIEF SUMMARY

Methods and apparatuses for MAC CE based beam failure recovery in multi-TRP scenario are disclosed.

In one embodiment, a method comprises transmitting a capability report on

supporting configuration of multiple BFD RS sets for a serving cell; and receiving a configuration including at least two NBI (new beam identification) RS sets and two BFI (beam failure indication) counters for the serving cell.

In one embodiment, the configuration may further include two BFD (beam failure detection) RS sets. Alternatively, the method may further include determining the two BFD RS sets.

In some embodiment, when the serving cell is a SpCell and both BFI counters for the SpCell is larger than a configured maximum counter value, the method may further include initiating a random access procedure, wherein, when at least one new beam is identified from a first NBI RS set of the two NBI RS sets, a contention free random access procedure is initiated; and when no new beam is identified from the first NBI RS set, a contention based random access procedure is initiated. A BFR MAC CE may be included in a MAC PDU as part of the random access procedure, wherein the BFR MAC CE indicates whether new beam is identified from a second NBI RS set of the two NBI RS sets and a candidate RS ID corresponding to the new beam if the new beam is identified from the second NBI RS set

In some embodiment, the serving cell is a SpCell or a SCell. The method may further comprise when only one of the two BFI counters for the SpCell is larger than a configured maximum counter value or when one or both of the two BFI counters for the SCell are larger than a configured maximum counter value, transmitting a BFR MAC CE. The BFR MAC CE contains a S field to indicate whether beam failure is detected for one of the two BFD RS sets for the SpCell. In particular, S=1 indicates that beam failure is detected for only one BFD RS set for the SpCell, and S=0 indicates that beam failure is not detected for any BFD RS set for the SpCell. When S=1, the BFR MAC CE further contains a T field to indicate the beam failure is detected for which BFD RS set for the SpCell. If two BFD RS sets are configured for a SCell, the BFR MAC CE contains two bits, each of which indicates whether beam failure is detected for one BFD RS set for the SCell.

In some embodiment, if two BFD RS sets are configured for the SpCell, the BFR MAC CE contains two bits, each of which indicates whether beam failure is detected for one BFD RS set for the SpCell.

In another embodiment, a remote unit comprises a transmitter that transmits a capability report on supporting configuration of multiple BFD RS sets for a serving cell; and a receiver that receives a configuration including at least two NBI (new beam identification) RS sets and two BFI (beam failure indication) counters for the serving cell. The configuration may further include two BFD (beam failure detection) RS sets. Otherwise, the remote unit further comprises a processor that determines the two BFD RS sets.

In one embodiment, a method comprises receiving a capability report on supporting configuration of multiple BFD RS sets for a serving cell; and transmitting a configuration including at least two NBI (new beam identification) RS sets and two BFI (beam failure indication) counters for the serving cell. The configuration may further include two BFD (beam failure detection) RS sets, when the two BFD RS sets are not determined by the remote unit.

In yet another embodiment, a base unit comprises a receiver that receives a capability report on supporting configuration of multiple BFD RS sets for a serving cell; and a transmitter that transmits a configuration including at least two NBI (new beam identification) RS sets and two BFI (beam failure indication) counters for the serving cell. The configuration may further include two BFD (beam failure detection) RS sets, when the two BFD RS sets are not determined by the remote unit.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a configuration for beam failure recovery in multi-TRP (e.g. two TRPs) scenario;

FIG. 2 illustrates a BFR MAC CE format with the highest ServCellIndex of the SCell configured with BFD is less than 8;

FIG. 3 illustrates a BFR MAC CE format with the highest ServCellIndex of the SCell configured with BFD is equal to or larger than 8;

FIGS. 4(a), 4(b) and 4(c) illustrate examples of the BFR MAC CE;

FIGS. 5 and 6 illustrate another BFR MAC CE format;

FIGS. 7(a), 7(b) and 7(c) illustrate other examples of the BFR MAC CE;

FIG. 8 is a schematic flow chart diagram illustrating an embodiment of a method;

FIG. 9 is a schematic flow chart diagram illustrating a further embodiment of a method; and

FIG. 10 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

When a UE is configured with multi-DCI based multi-TRP DL transmission mode, i.e. different higher layer CORESETPoolIndex values are configured for the CORESETs configured in a cell by RRC signaling for TRP differential, a UE transmits a capability report to the gNB, wherein the capability report indicates that per TRP BFR is supported (i.e. configuration of multiple BFD RS sets is supported) for the cell. The cell can be a SpCell or a SCell. A CORESET configures a set of frequency-time resources for PDCCH transmission.

When the gNB receives the capability report indicating that per TRP BFR is supported for the cell, the gNB transmits to the UE a configuration of multiple (e.g. two) BFD (beam failure detection) RS sets, multiple (e.g. two) NBI (new beam identification) RS sets, and multiple (e.g. two) BFI (beam failure indication) counters for the cell. The two BFD RS sets (e.g. BFD RS Set#1 and BFD RS Set#2), the two NBI RS sets (e.g. NBI RS set#1 and NBI RS set#2) and the two BFI counters (e.g. BFI-Counter#1 and BFI-counter#2) of the configuration are TRP-specific. Each BFD RS set (e.g. BFD RS Set#1) is associated with a BFI counter (e.g. BFI-Counter#1) and is further associated with a NBI RS set (e.g. NBI RS set#1). In addition, the associated BFD RS set, BFI counter and NBI RS set are associated with one TRP of the cell. For example, when the cell has two TRPs (e.g. TRP#1 and TRP#2), it means that BFD RS Set#1, NBI RS set#1 and BFI-Counter#1 are associated with one TRP (e.g. TRP#1), BFD RS Set#2, NBI RS set#2 and BFI-Counter#2 are associated with the other TRP (e.g. TRP#2).

In the above embodiment, the two BFD RS sets are explicitly indicated by the gNB to the UE. Alternatively, if the UE can determine the two BFD RS sets by itself, the gNB may only transmit to the UE a configuration of the two NBI RS sets and the two BFI counters (i.e. without the two BFD RS sets). The UE may determine the two BFD RS sets in a way that is known by the gNB. In particular, the UE determines the BFD RS sets to include periodic CSI-RS resource configuration indices with the same values as the RS indices in the RS sets indicated by the TCI state, which contains one or two RSs with different QCL types, configured for respective CORESET that the UE uses for monitoring PDCCH and, if there are two RS indices in a TCI state, the BFD RS set includes RS indices with QCL-TypeD configuration for the corresponding TCI state. For example, if five CORESETs, e.g. CORESET#1, CORESET#2, CORESET#3, CORESET#4 and CORESET#5, are configured for a UE in a BWP, a higher layer parameter CORESETPoolIndex=0 is configured for CORESET#1, CORESET#2 and CORESET#3 and CORESETPoolIndex=1 is configured for CORESET#4 and CORESET#5, the UE determines BFD RS set#1 to include periodic CSI-RS resource configuration indices with the same values as the QCL-TypeD RS indices in the TCI states configured for CORESET#1, CORESET#2 and CORESET#3 and determines BFD RS set#2 to include periodic CSI-RS resource configuration indices with same values as the QCL-TypeD RS indices in the TCI states configured for CORESET#4 and CORESET#5.

The transmission of the capability report from UE to gNB and the receiving of the configuration from gNB to UE are made per cell. That is, the UE transmits a capability report for each of the serving cells supporting configuration of multiple BFD RS sets, and receives a configuration for each of the transmitted capability reports.

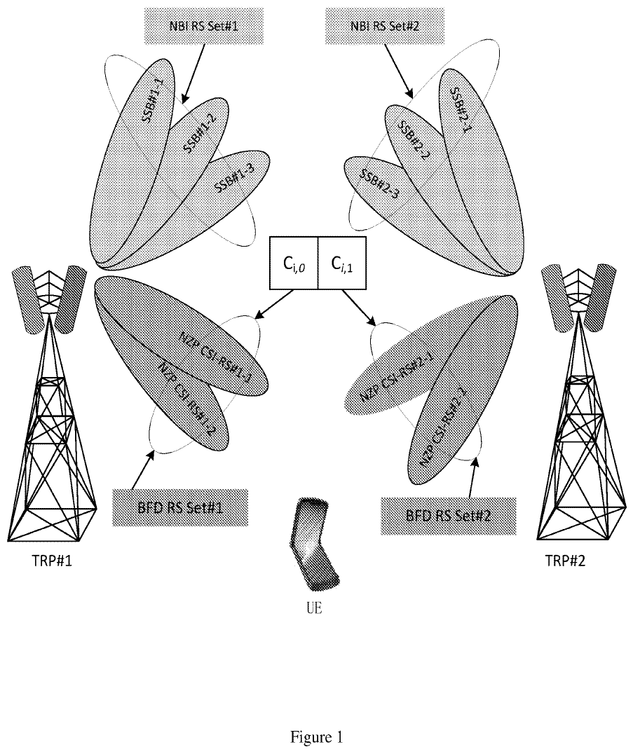

FIG. 1 illustrates a beam failure detection for a UE configured with multi-TRP (e.g. two TRPs) for a cell. As shown in FIG. 1, TRP#1 and TRP#2 are configured in a cell for a UE in multi-DCI based multi-TRP DL transmission mode. The cell can be either a SpCell or a SCell. Two BFD RS sets (e.g. BFD RS Set#1 and BFD RS Set#2) (indicated by the gNB or determined by the UE) are configured for the cell for beam failure detection for TRP#1 and TRP#2, respectively. Each of BFD RS Set#1 and BFD RS Set#2 may be composed of multiple NZP CSI-RSs (e.g. two NZP CSI-RSs). In FIG. 1, BFD RS Set#1 is composed of NZP CSI-RS#1-1 and NZP CSI-RS#1-2; while BFD RS Set#2 is composed of NZP CSI-RS#2-1 and NZP CSI-RS#2-2. FIG. 1 also illustrates C_{i,0} and C_{i,1}. C_{i,0} and C_{i,1} are contained in a BFR MAC CE to represent respectively the first BFD RS set (e.g. BFD RS set #1) and the second BFD RS set (e.g. BFD RS set #2) of the cell. The BFR MAC CE is sent in beam failure recovery request procedure and will be described later.

When the radio link qualities of all NZP CSI-RSs in a BFD RS set are worse than a preconfigured threshold, the physical layer (lower layer) in the UE reports a beam failure event for the TRP associated with the BFD RS set to MAC entity (higher layer). In particular, the physical layer in the UE provides to the MAC entity a beam failure indication (BFI) to indicate a failure of the TRP associated with the BFD RS set. Accordingly, the MAC entity increases an associated BFI-Counter (i.e. the BFI-Counter associated with the TRP and also associated with the BFD RS set) by 1 if the BFI is received from the physical layer. A higher layer parameter beamFailureInstanceMaxCount can be configured for the BFI-Counter. The higher layer parameter beamFailureInstanceMaxCount determines after how many beam failure events the UE triggers beam failure recovery request procedure. That is, when BFI-Counter>=beamFailureInstanceMaxCount, a random access procedure may be initiated or a BFR MAC CE may be sent.

Different beamFailureInstanceMaxCount values can be configured for different BFI-Counters associated with different BFD RS sets. For example, a higher layer parameter beamFailureInstanceMaxCount#1 is configured for BFI-Counter#1 associated with BFD RS Set#1. In addition, a higher layer parameter beamFailureInstanceMaxCount#2 is configured for BFI-Counter#2 associated with BFD RS Set#2. If only one beamFailureInstanceMaxCount is configured and two BFI-Counters (e.g. BFI-Counter#1 and BFI-Counter#2) are configured, beamFailureInstanceMaxCount applies to both BFI-Counters. When the radio link qualities of all NZP CSI-RSs (e.g. both NZP CSI-RS#1-1 and NZP CSI-RS#1-2 shown in FIG. 1) in BFD RS set#1 are worse than a preconfigured threshold (e.g. Qₒᵤₜ₁), the physical layer in the UE provides to the MAC entity an beam failure indication (BFI) to indicate a failure of TRP#1 associated with BFD RS set#1. Accordingly, the MAC entity increases BFI-Counter#1 associated with BFD RS set#1 by 1. Similarly, when the radio link qualities of all NZP CSI-RSs (e.g. both NZP CSI-RS#2-1 and NZP CSI-RS#2-2 shown in FIG. 1) in BFD RS set#2 are worse than a preconfigured threshold (e.g. Qₒᵤₜ₂), the physical layer in the UE provides to the MAC entity a beam failure indication (BFI) to indicate a failure of TRP#2 associated with BFD RS set#2. Accordingly, the MAC entity increases BFI-Counter#2 associated with BFD RS set#2 by 1.

When the cell is a SpCell, if BFI-Counter#1>=beamFailureInstanceMaxCount#1 and BFI-Counter#2>=beamFailureInstanceMaxCount#2, the MAC entity shall initiate a random access procedure on the SpCell for beam failure recovery request (BFRQ) transmission.

NBI RS set#1 and NBI RS set#2 are configured for the UE for new beam identification for TRP#1 and TRP#2, respectively. As mentioned earlier, NBI RS set#1 and NBI RS set#2 are associated with BFD RS set#1 and BFD RS set#2, respectively, and accordingly, associated with TRP#1 and TRP#2, respectively. Up to M RSs (e.g. SSB resources) can be included in one NBI RS set, wherein M depends on UE capability reporting. As shown in the example of FIG. 1, NBI RS set#1 includes three RSs: SSB#1-1, SSB#1-2 and SSB#1-3; while NBI RS set#2 includes three RSs: SSB#2-1, SSB#2-2 and SSB#2-3. One RS (e.g. one of SSB#1-1, SSB#1-2 and SSB#1-3) can be identified as a new beam when the radio link quality thereof is higher than a predetermined threshold Qᵢₙ. If the radio link quality of each of the RSs (e.g. each of SSB#1-1, SSB#1-2 and SSB#1-3) included in a NBI RS set (e.g. NBI RS set#1) is lower than the predetermined threshold Qᵢₙ, no new beam is identified from the NBI RS set (e.g. NBI RS set#1).

In particular, when at least one new beam is identified from the NBI RS set#1 configured for TRP#1, the UE shall use contention free random access (CFRA) for BFRQ transmission in SpCell. In addition, if there is available uplink resource, a BFR MAC CE can be included in a MAC PDU as part of the random access procedure. Whether new beam is identified in the NBI RS set#2 and the beam index of the identified new beam (if identified) are indicated in the BFR MAC CE.

When no new beam is identified from the NBI RS set#1 configured for TRP#1, the UE shall use contention based random access (CBRA) for BFRQ transmission.

When the cell is a SpCell, if BFI-Counter#1>=beamFailureInstanceMaxCount#1 or BFI-Counter#2>=beamFailureInstanceMaxCount#2, the MAC entity shall trigger a MAC CE based BFR procedure for the SpCell. It means that the UE sends a BFR MAC CE to indicate the BFR status for each TRP. If there is available UL-SCH resource, the UE sends BFR MAC CE on the available UL-SCH resource. If there is no available UL-SCH resource, the UE sends a PUCCH-BFR, which is a PUCCH resource used for schedule request with higher priority than normal schedule request, to request a PUSCH resource for transmission of the BFR MAC CE. The failed BFD RS set ID and the identified new beam (if identified) are indicated in the BFR MAC CE.

When the cell is a SCell, if BFI-Counter#1>=beamFailureInstanceMaxCount#1 and/or BFI-Counter#2>=beamFailureInstanceMaxCount#2, the MAC entity shall trigger a MAC CE based BFR for the SCell. It means that the UE sends BFR MAC CE. If there is available UL-SCH resource, the UE sends BFR MAC CE on the available UL-SCH resource. If there is no available UL-SCH resource, the UE sends a PUCCH-BFR to request a PUSCH resource for BFR MAC CE transmission. The failed BFD RS set ID and the identified new beam(s) (if identified) are indicated in the BFR MAC CE.

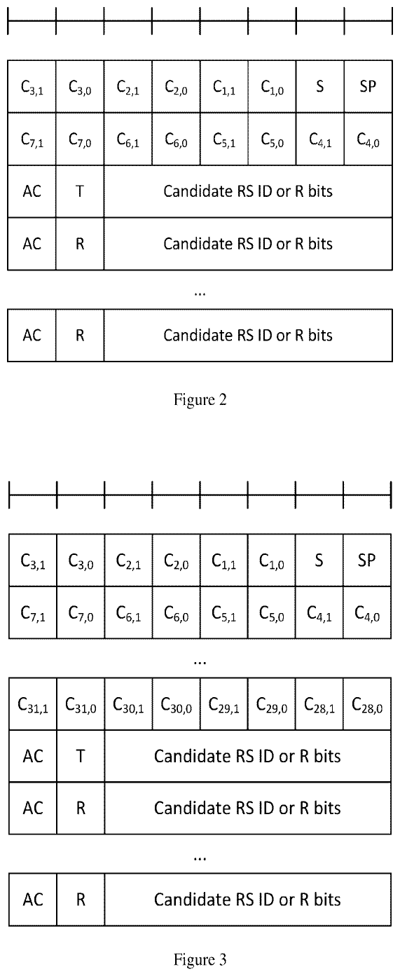

The formats of the BFR MAC CE (which can be either included in a MAC PDU as part of the random access procedure, or sent on available UL-SCH resource or on PUSCH resource requested by PUCCH-BFR) are described with reference to FIGS. 2 and 3. A UE is configured with multiple serving cells including one SpCell and at least one SCell. At least one serving cell is configured with multi-TRP (e.g. two TRPs). For each of the serving cells configured with multi-TRP (e.g. two TRPs), a configuration of two BFD RS sets, two NBI RS sets and two BFI counters are received by the UE after the UE transmits a capability report indicating that per-TRP BFR is supported for the serving cell. As described earlier, the two BFD RS sets may be determined by the UE itself. It is not necessary that all serving cells for the UE are configured with multi-TRP. In other words, some serving cell(s) for the UE may be configured with single TRP. Each serving cell is identified by a ServCellIndex.

In the format of the BFR MAC CE illustrated in FIG. 2, the highest ServCellIndex of this MAC entity's SCell configured with BFD is less than 8 (i.e. from 1 to 7) and two BFD RS sets are configured for at least one serving cell (SpCell and/or SCell). A cell configured with multiple BFD RS sets (e.g. two BFD RS sets) means that the cell is configured with multi-TRP and per TRP BFR is supported. In the format of the BFR MAC CE illustrated in FIG. 3, the highest ServCellIndex of this MAC entity's SCell configured with BFD is equal to or larger than 8 (i.e. from 8 to 31) and two BFD RS sets are configured for at least one serving cell (SpCell and/or SCell).

As shown in each of FIGS. 2 and 3, the BFR MAC CE includes the following fields:

SP: This field has a length of 1 bit and indicates beam failure detection for the SpCell of this MAC entity. SP=1 indicates that beam failure is detected for both configured BFD RS sets of SpCell only when BFR MAC CE is to be included into a MAC PDU as part of Random Access Procedure. Otherwise, SP is set to 0. When SP=1, an octet containing a AC field (which will be described later) is present, wherein the AC field indicates whether new beam is identified from the second NBI RS set (e.g. NBI RS set#2 shown in FIG. 1); and the new beam (if identified) is indicated by a Candidate RS ID field (which will be described later) within the octet containing the AC field.

S: This field has a length of 1 bit and indicates whether beam failure is detected for SpCell. S field is only presented when the SP field is set to 0. S=1 indicates that beam failure is detected from either the first BFD RS set or the second BFD RS set configured on the SpCell.

C_{i,j} (or Cᵢ):This field has a variable size (depending on the number of serving cells and the number of serving cells configured with multiple BFD RS sets) and indicates beam failure detection and the presence of an octet containing the AC field for the SCell with ServCellIndex i. The index i ranges from 1 to the highest ServCellIndex (up to 7 in FIG. 2 and up to 31 in FIG. 3). If the cell with ServCellIndex i is configured with two BFD RS sets, the index j can be 0 or 1. C_{i,j} represents the (j+1)^{th} BFD RS set of the cell with ServCellIndex i. In particular, C_{i,0} represents the first BFD RS set (e.g. BFD RS set #1 in FIG. 1) of the cell with ServCellIndex i, and Co represents the second BFD RS set (e.g. BFD RS set #2 in FIG. 1) of the cell with ServCellIndex i. If the cell with ServCellIndex i is configured with only one BFD RS set, only Cᵢ is presented to represent the BFD RS set of the cell with ServCellIndex i.

C_{i,j}=1 indicates that beam failure is detected and the octet containing the AC field is present for the (j+1)^{th} BFD RS set (associated with the (j+1)^{th} TRP) of SCell with ServCellIndex i. C_{i,j}=0 indicates that the beam failure is not detected and octet containing the AC field is not present for the (j+1)^{th} BFD RS set (associated with the (j+1)^{th} TRP) of SCell with ServCellIndex i. Cᵢ=1 indicates that beam failure is detected and the octet containing the AC field is present for the BFD RS set of SCell with ServCellIndex i. Cᵢ=0 indicates that the beam failure is not detected and octet containing the AC field is not present for the BFD RS set of SCell with ServCellIndex i. The octets containing the AC field are present in ascending order based on the ServCellIndex i. For the same ServCellIndex i, the octets containing the AC field are present in ascending order based on the index j.

AC: Each AC field has a length of 1 bit and is positioned in the first bit of an octet and indicates the presence or non-presence of the Candidate RS ID field in this octet. If at least one RS in NBI RS set#1 (for C_{i,0}=1) or NBI RS set#2 (for C_{i,1}=1) (or at least one RS in NBI RS set (for Cᵢ=1)) is identified as new beam, the AC field is set to 1. Otherwise, it is set to 0. If the AC field is set to 1, the Candidate RS ID field (6 bits) is present in this octet. If the AC field is set to 0, six R (Reserved) bits are present to replace the Candidate RS ID field.

T: This field has a length of 1 bit and indicates the beam failure is detected for which BFD RS set for SpCell when beam failure is detected for only one BFD RS set of the SpCell. T=0 indicates that beam failure is only detected for the first BFD RS set (e.g. BFD RS set#1 associated with TRP#1 in FIG. 1). T=1 indicates that beam failure is only detected for the second BFD RS set (e.g. BFD RS set#2 associated with TRP#2 in FIG. 1). This field is only present when the S field is set to 1. When the S field is set to 0, this field is replaced with one R (Reserved) bit.

Candidate RS ID: Each “Candidate RS ID” field is set to the index of the identified new beam in NBI RS set#1 (for C_{i,0}=1) or in NBI RS set#2 (for C_{i,1}=1) or in NBI RS set (for Cᵢ=1). The length of each “Candidate RS ID” field is 6 bits. Each “Candidate RS ID” field in included in the last 6 bits of an octet including a AC field in the first bit.

R: Reserved bit, set to 0.

FIGS. 2 and 3 illustrate that the ServCellIndex i ranges from 1 to 7 or 1 to 31. That is the serving cell index for SCells in a MCG or SCG. The ServCellIndex 0 that represents the SpCell does not appear in the BER MAC CE. That is, C_{0,0}, C_{0,1}, or C₀ is not included in the BER MAC CE, since whether beam failure is detected for the BFD RS set(s) of the SpCell is indicated by the S field and the T field or implicitly identified in the random access procedure.

Below is a summarization of different BFRQ transmissions in different situations.

Situation 1: when beam failure is detected for both BFD RS sets of SpCell (BFI-Counter#1>=beamFailureInstanceMaxCount#1 and BFI-Counter#2>=beamFailureInstanceMaxCount#2 for SpCell), a random access procedure is initiated for BFRQ transmission. A BFR MAC CE may be included into a MAC PDU as part of the random access procedure. The SP field of BFR MAC CE is set to 1 (SP=1).

Situation 1-1: if at least one new beam is identified from NBI RS set#1 of SpCell, contention free random access (CFRA) for BFRQ transmission is used. In addition, one octet including AC field (1 bit) may be included in the BFR MAC CE.

Situation 1-1-1: if new beam is identified from NBI RS set#2 of SpCell, the AC field is set to 1, and the octet including the AC field also includes a Candidate RS ID field (6 bits) that is set to the index of the new beam, as well as one reserved bit.

Situation 1-1-2: if no new beam is identified from NBI RS set#2 of SpCell, the AC field is set to 0 (AC=0), the octet including the AC field also includes 7 reserved bits.

Situation 1-2: if no new beam is identified from NBI RS set#1 of SpCell, contention based random access (CBRA) for BFRQ transmission is used.

Situation 2: when beam failure is detected from BFD RS set#1 or BFD RS set#2 of SpCell (BFI-Counter#1>=beamFailureInstanceMaxCount#1 or BFI-Counter#2>=beamFailureInstanceMaxCount#2 for SpCell), the SP field of BFR MAC CE is set to 0 (SP=0), and the S field of BFR MAC CE is set to 1 (S=1).

Situation 2-1: when beam failure is detected from BFD RS set#1 of SpCell (BFI-Counter#1>=beamFailureInstanceMaxCount#1 for SpCell) and is not detected from BFD RS set#2 of SpCell (BFI-Counter#2<beamFailureInstanceMaxCount#2 for SpCell), the T field of BFR MAC CE is set to 0 (T=0).

Situation 2-1-1: if new beam is identified from NBI RS set#1 of SpCell, the AC field is set to 1 (AC=1), and the octet including the AC field further includes the T field (1 bit, set to 0) and a Candidate RS ID field (6 bits) that is set to the index of the identified new beam.

Situation 2-1-2: if no new beam is identified from NBI RS set#1 of SpCell, the AC field is set to 0 (AC=0), the octet including the AC field further includes the T field (1 bit, set to 0) and 6 reserved bits.

Situation 2-2: when beam failure is detected from BFD RS set#2 of SpCell (BFI-Counter#2>=beamFailureInstanceMaxCount#2 for SpCell), and is not detected from BFD RS set#1 of SpCell (BFI-Counter#1<beamFailureInstanceMaxCount#1 for SpCell), the T field of BFR MAC CE is set to 1 (T=1).

Situation 2-2-1: if new beam is identified from NBI RS set#2 of SpCell, the AC field is set to 1 (AC=1), and the octet including the AC field further includes the T field (1 bit, set to 1) and a Candidate RS ID field (6 bits) that is set to the index of the identified new beam.

Situation 2-2-2: if no new beam is identified from NBI RS set#2 of SpCell, the AC field is set to 0 (AC=0), the octet including the AC field further includes the T field (1 bit, set to 1) and 6 reserved bits.

Situation 3: when beam failure is detected from BFD RS set#1 and/or BFD RS set#2 of SCell (BFI-Counter#1>=beamFailureInstanceMaxCount#1 and/or BFI-Counter#2>=beamFailureInstanceMaxCount#2 for SCell), the SP field of BFR MAC CE is set to 0 (SP=0) (when beam failure is not detected from both BFD RS set#1 and BFD RS set#2 of SpCell), and the S field of BFR MAC CE is set to 0 (when beam failure is not detected from either BFD RS set#1 or BFD RS set#2 of SpCell) or 1 (when beam failure is also detected from BFD RS set#1 or BFD RS set#2 of SpCell). If the SCell with ServCellIndex i is configured with multiple BFD RS sets, C_{i,j} (i=1 to the highest ServCellIndex (up to 7 for the format in FIG. 2 or up to 31 for the format in FIG. 3), and j=0 to 1) is included in the BFR MAC CE; and if the SCell with ServCellIndex i is configured with single BFD RS set, Cᵢ is included in the BFR MAC CE. Each of C_{i,j} and Cᵢ is 1 bit, and is positioned in the BFR MAC CE in ascending order of the ServCellIndex, and for C_{i,j} (j=0 to 1) with the same ServCellIndex i, C_{i,0} is positioned in front of C_{i,1}. C_{i,j}=1 indicates beam failure is detected from BFD RS set#(j+1) of SCell i (Cᵢ=1 indicates beam failure is detected from BFD RS set of SCell i). C_{i,j}=0 indicates beam failure is not detected from BFD RS set#(j+1) of SCell i (Cᵢ=0 indicates beam failure is not detected from BFD RS set of SCell i). For each C_{i,j} or Cᵢ that is set to 1, an octet including the AC field is included in the BFR MAC CE. If a multiple of octets including the AC field is included in the BFR MAC CE, they are positioned based on ascending order of i and for the same i based on ascending order of j. If new beam is identified from NBI RS set#(j+1) of SCell i (or new beam is identified from NBI RS set of SCell i), the AC field in the octet is set to 1 (AC=1), and the octet including the AC field being set to 1 further includes one reserved bit and a Candidate RS ID field (6 bits) that is set to the index of the identified new beam. If no new beam is identified from NBI RS set#(j+1) of SCell i (or no new beam is identified from NBI RS set of SCell i); the AC field in the octet is set to 0 (AC=0), and the octet including the AC field being set to 0 further includes seven reserved bits. It can be seen that, for Situation 3, if beam failure is detected from BFD RS set(s) of two or more SCells, the failed BFD RS set(s) for the two or more SCells as well as whether new beam(s) are identified for each of the failed BFD RS set(s) and the new beam(s) (if identified) can be included in one BFR MAC CE.

Situation 2 and Situation 3 can be combined. It means that if beam failure is detected from only one BFD RS set (e.g. BFD RS set#1 or BFD RS set#2) of the SpCell and from BFD RS set(s) of one or more SCells, only one BFR MAC CE is sent. In the BFR MAC CE, the S field is set to 1; and an octet including AC field (1 bit), T field (1 bit) and “Candidate RS ID” field or R field (6 bits) is contained in the BFR MAC CE (the AC field being set to 1 or 0 and the T field being set to 1 or 0 are similar to the above description of Situations 2-1-1, 2-1-2, 2-2-1 and 2-2-2). The failed BFD RS set(s) of the one or more SCells are indicated by setting the corresponding C_{i,j} or Cᵢ field to 1; and a number (which is equal to the number of failed BFD RS set(s) of the one or more SCells) of octets including AC field (1 bit), R field (1 bit) and “Candidate RS ID” field or R field (6 bits) are contained in the BFR MAC CE. The order of the octets including the AC field are as follows: the octet for the failed BFD RS set of the SpCell is positioned in front of the octet(s) for the failed BFD RS set(s) of the SCell(s), and the order of the octet(s) for the failed BFD RS set(s) of the SCell(s) is according to the same order as described in Situation 3.

In addition, Situation 1 and Situation 3 can be also combined. It means that if beam failure is detected from both BFD RS sets of the SpCell and from BFD RS set(s) of one or more SCells, and if a BFR MAC CE is included in a MAC PDU as part of the random access procedure, the BFR MAC CE includes the indication of failed BFD RS sets of the SpCell and of the one or more SCells as well as the identified new beams (or no new beam is identified for a failed BFD RS set). In particular, the SP field is set to 1; and an octet including AC field (1 bit), R field (1 bit) and “Candidate RS ID” field or R field (6 bits) is contained in the BFR MAC CE to indicate whether new beam is identified from NBI RS set#2 of SpCell (the AC field being set to 1 or 0 is similar to the above description of Situations 1-1-1, 1-1-2). The failed BFD RS set(s) of the one or more SCells are indicated by setting the corresponding C_{i,j} or Cᵢ field to 1; and a number (which is equal to the number of failed BFD RS set(s) of the one or more SCells) of octets including AC field (1 bit), R field (1 bit) and “Candidate RS ID” field or R field (6 bits) are contained in the BFR MAC CE. The order of the octets including the AC field are as follows: the octet for the BFD RS set#2 of the SpCell is positioned in front of the octet(s) for the failed BFD RS set(s) of the one or more SCells, and the order of the octet(s) for the failed BFD RS set(s) of the one or more SCells is according to the same order as described in Situation 3.

It can be seen that multiple failed BFD RS sets and the identified new beam(s) (or no new beam(s) is identified) can be indicated in one BFR MAC CE.

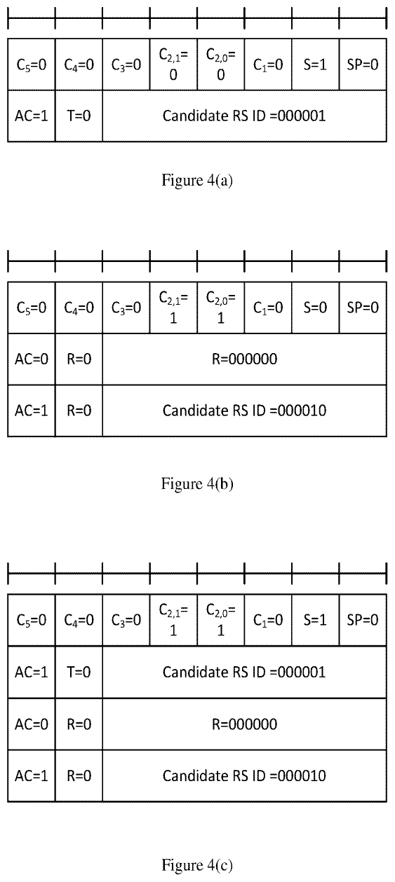

FIGS. 4(a), 4(b) and 4(c) illustrate three examples of the BFR MAC CE in situation 2-1-1, in situation 3, and in a combination of situation 2-1-1 and situation 3. In particular, a UE is configured with 6 serving cells, e.g. serving cell with ServCellIndex 0, 1, . . . , 5 (in which serving cell with ServCellIndex 0 is PCell (i.e. SpCell), and serving cells with other ServCellIndex 1 to ServCellIndex 5 are SCells). Multi-TRP (e.g. two TRPs) operation is configured for the PCell with ServCellIndex 0 and the SCell with ServCellIndex 2. Single TRP is configured for other SCells with ServCellIndex 1 or 3 or 4 or 5. A first capability report for the PCell with ServCellIndex 0 is transmitted from the UE to gNB; and a first configuration of two BFD RS sets, two NBI RS sets and two BFI counters is received from the gNB. Note that the first configuration may not include the two BFD RS sets. In this condition, the two BFD RS sets (for the PCell) are determined by the UE. Suppose that the BFD RS sets and NBI RS sets of the PCell are configured as shown in FIG. 1. A second capability report for the SCell with ServCellIndex 2 is transmitted from the UE to gNB; and a second configuration of two BFD RS sets, two NBI RS sets and two BFI counters is received from the gNB. Note that the second configuration may not include the two BFD RS sets. In this condition, the two BFD RS sets (for the SCell with ServCellIndex 2) are determined by the UE. Suppose the BFD RS sets and NBI RS sets of the SCell with ServCellIndex 2 are configured also as shown in FIG. 1.

Example 1 (FIG. 4(a)): All beams in BFD RS set#1 of PCell are failed and the associated BFI-Counter#1 is equal to (or larger than) the maximum value beamFailureInstanceMaxCount#1, while beams in BFD RS set#2 of PCell are good enough (BFI-Counter#2<beamFailureInstanceMaxCount#2). The UE identifies the beam corresponding to SSB#1-2 (with ID 000001) in NBI RS set#1 as the new beam. All beams in BFD RS sets of SCells with ServCellIndex 1, 3, 4 and 5 and all beams in BFD RS set#1 and BFD RS set#2 of SCell with ServCellIndex 2 are good enough. The UE may transmit a PUCCH-BFR (when there is no available UL-SCH resource) to schedule a PUSCH transmission for BFR MAC CE transmission, and shall transmit the BFR MAC CE with the value provided in FIG. 4(a).

Example 2 (FIG. 4(b)): All beams in both BFD RS set#1 and BFD RS set#2 of SCell with ServCellIndex 2 are failed, and the BFI-Counter#1 is equal to (or larger than) the maximum value beamFailureInstanceMaxCount#1, and the BFI-Counter#2 is equal to (or larger than) the maximum value beamFailureInstanceMaxCount#2. The UE only identifies the beam corresponding to SSB#2-3 (with index 000010) in NBI RS set#2 as the new beam. The UE does not identify any beam in NBI RS set#1 as new beam. All beams in BFD RS sets of SCells with ServCellIndex 1, 3, 4 and 5 and all beams in BFD RS set#1 and BFD RS set#2 of PCell with ServCellIndex 0 are good enough. The UE may transmit a PUCCH-BFR (when there is no available UL-SCH resource) to schedule a PUSCH transmission for BFR MAC CE transmission, and shall transmit the BFR MAC CE with the value provided in FIG. 4(b).

Example 3 (FIG. 4(c)): All beams in BFD RS set#1 of PCell are failed and the associated BFI-Counter#1 is equal to (or larger than) the maximum value beamFailureInstanceMaxCount#1, while beams in BFD RS set#2 of PCell are good enough (BFI-Counter#2<beamFailureInstanceMaxCount#2). The UE identifies the beam corresponding to SSB#1-2 (with ID 000001) in NBI RS set#1 of PCell as the new beam. All beams in both BFD RS set#1 and BFD RS set#2 of SCell with ServCellIndex 2 are failed, and the BFI-Counter#1 is equal to (or larger than) the maximum value beamFailureInstanceMaxCount#1, and the BFI-Counter#2 is equal to (or larger than) the maximum value beamFailureInstanceMaxCount#2. The UE only identifies the beam corresponding to SSB#2-3 (with index 000010) in NBI RS set#2 of SCell with ServCellIndex 2 as the new beam. The UE does not identify any beam in NBI RS set#1 of SCell with ServCellIndex 2 as new beam. All beams in BFD RS sets of SCells with ServCellIndex 1, 3, 4 and 5 are good enough. The UE may transmit a PUCCH-BFR (when there is no available UL-SCH resource) to schedule a PUSCH transmission for BFR MAC CE transmission, and shall transmit the BFR MAC CE with the value provided in FIG. 4(c).

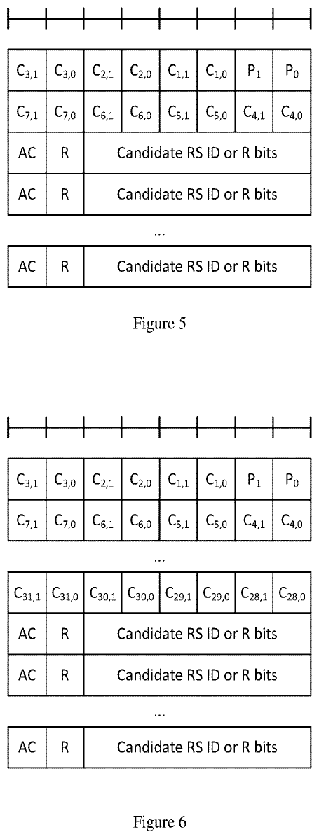

In the BFR MAC CE formats shown in FIGS. 2 and 3, the SP field, the S field and the T field are used to indicate whether beam failure is detected for two BFD RS sets of the SpCell. In particular, SP=1 indicates beam failure being detected for both BFD RS set#1 and BFD RS set#2; SP=0, S=1 and T=0 indicates beam failure being detected for BFD RS set#1, while SP=0, S=1 and T=1 indicates beam failure being detected for BFD RS set#2. FIGS. 5 and 6 illustrate two alternative BFR MAC CE formats. The BFR MAC CE format of FIG. 5 (or FIG. 6) differs from that of FIG. 2 (or FIG. 3) in that the SP field, the S field and the T field are replaced by P₀ and P₁ fields. The P₀ and P₁ fields can be positioned in front of C_{i,j} (or Cᵢ) field. Pᵢ (i=0 or 1) field indicates whether beam failure is detected for the (i+1)^{th} BFD-RS set of the SpCell. Pᵢ=1 indicates that beam failure is detected and the octet containing the AC field is present for the (i+1)^{th} BFD RS set of SpCell. Note that for the Situation 1 in which beam failure is detected for both BFD RS sets of SpCell (i.e. both P₀ and P₁ fields are set to 1), only the octet containing the AC field is present for the second BFD RS set (associated with TRP#2) of SpCell, while the octet containing the AC field is not present for the first BFD RS set (associated with TRP#1) of SpCell since the new beam for the first BFD RS set (associated with TRP#1) of SpCell is implicitly indicated in the random access procedure. Pᵢ=0 indicates that the beam failure is not detected and octet containing the AC field is not present for the (i+1)^{th} BFD RS set of SpCell. The other fields (e.g. C_{i,j} (or Cᵢ) field, AC field and Candidate RS ID field) included in FIG. 5 or FIG. 6 are the same as those included in FIG. 2 or FIG. 3. The octets containing the AC field are present in ascending order of ServCellIndex (note that SpCell always has the lowest ServCellIndex 0), and for C_{i,j} (i=1 to 7 (in FIG. 5) or 31 (in FIG. 6) (j=0 to 1) with the same ServCellIndex i, the octet for C_{i,0} is positioned in front of the octet for C_{i,1}.

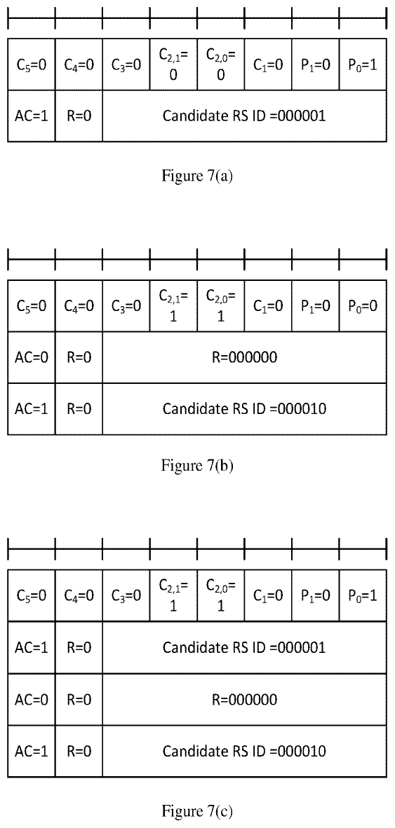

FIGS. 7(a), 7(b) and 7(c) illustrate the BFR MAC CEs corresponding to FIGS. 4(a), 4(b) and 4(c) if the BFR MAC CE formats shown in FIG. 5 or 6 is used.

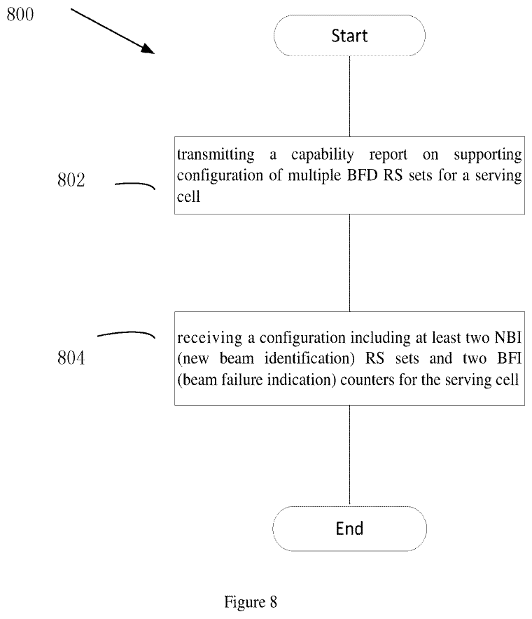

FIG. 8 is a schematic flow chart diagram illustrating an embodiment of a method 800 according to the present application. In some embodiments, the method 800 is performed by an apparatus, such as a remote unit. In certain embodiments, the method 800 may be performed by a processor executing program code, for example, a microcontroller, a microprocessor, a CPU, a GPU, an auxiliary processing unit, a FPGA, or the like.

The method 800 may include 802 transmitting a capability report on supporting configuration of multiple BFD RS sets for a serving cell; and 804 receiving a configuration including at least two NBI (new beam identification) RS sets and two BFI (beam failure indication) counters for the serving cell. The configuration may further include two BFD (beam failure detection) RS sets. Alternatively, the method may further include determining the two BFD RS sets.

When the serving cell is a SpCell and both BFI counters for the SpCell are larger than a configured maximum counter value, the method may further include initiating a random access procedure, wherein, when at least one new beam is identified from a first NBI RS set of the two NBI RS sets, a contention free random access procedure is initiated; and when no new beam is identified from the first NBI RS set, a contention based random access procedure is initiated. A BFR MAC CE may be included in a MAC PDU as part of the random access procedure, wherein the BFR MAC CE indicates whether new beam is identified from a second NBI RS set of the two NBI RS sets and a candidate RS ID corresponding to the new beam if the new beam is identified from the second NBI RS set.

The method may further include transmitting a BFR MAC CE when only one of the two BFI counters for the SpCell (when the serving cell is a SpCell) are larger than a configured maximum counter value or when one or both of the two BFI counters for the SCell (when the serving cell is a SCell) are larger than a configured maximum counter value. The BFR MAC CE contains a S field to indicate whether beam failure is detected for one of the two BFD RS sets for the SpCell. S=1 indicates that beam failure is detected for only one BFD RS set for the SpCell. When S=1, the BFR MAC CE further contains a T field to indicate the beam failure is detected for which BFD RS set for the SpCell. S=0 indicates that beam failure is not detected for any BFD RS set for the SpCell. If two BFD RS sets are configured for a SCell, the BFR MAC CE contains two bits, each of which indicates whether beam failure is detected for one BFD RS set for the SCell. If two BFD RS sets are configured for the SpCell, the BFR MAC CE contains two bits to replace the SP field, the S field and the T field, each of the two bits indicates whether beam failure is detected for one BFD RS set for the SpCell.

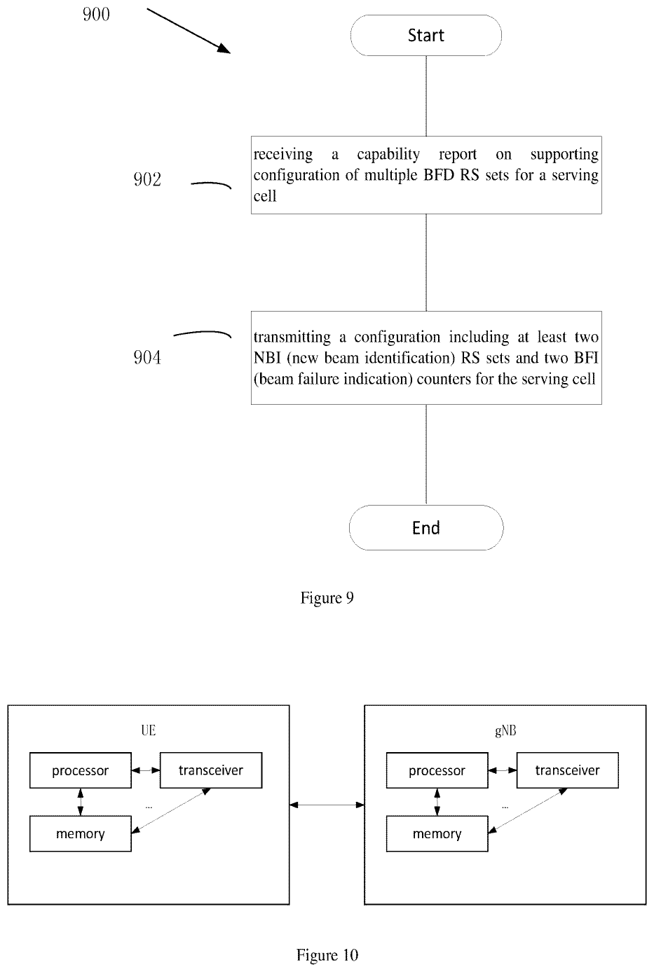

FIG. 9 is a schematic flow chart diagram illustrating an embodiment of a method 900 according to the present application. In some embodiments, the method 900 is performed by an apparatus, such as a base unit. In certain embodiments, the method 900 may be performed by a processor executing program code, for example, a microcontroller, a microprocessor, a CPU, a GPU, an auxiliary processing unit, a FPGA, or the like.

The method 900 may include 902 receiving a capability report on supporting configuration of multiple BFD RS sets for a serving cell; and 904 transmitting a configuration including at least two NBI (new beam identification) RS sets and two BFI (beam failure indication) counters for the serving cell. The configuration may further include two BFD (beam failure detection) RS sets.

The method may further include receiving a BFR MAC CE included in a MAC PDU, wherein the BFR MAC CE indicates whether new beam is identified from a second NBI RS set of the two NBI RS sets and a candidate RS ID corresponding to the new beam if the new beam is identified from the second NBI RS set.

The method may further comprise receiving a BFR MAC CE on an uplink resource. The BFR MAC CE may contain a S field to indicate whether beam failure is detected for one of the two BFD RS sets for the SpCell. In particular, S=1 indicates that beam failure is detected for only one BFD RS set for the SpCell, and S=0 indicates that beam failure is not detected for any BFD RS set for the SpCell. When S=1, the BFR MAC CE further contains a T field to indicate the beam failure is detected for which BFD RS set for the SpCell. The BFR MAC CE may further contain two bits, each of which indicates whether beam failure is detected for one BFD RS set for the SCell. The BFR MAC CE may further contain two bits to replace the SP field, the S field and the T field, each of the two bits indicates whether beam failure is detected for one BFD RS set for the SpCell.

FIG. 10 is a schematic block diagram illustrating apparatuses according to one embodiment.

Referring to FIG. 10, the UE (i.e. the remote unit) includes a processor, a memory, and a transceiver. The processor implements a function, a process, and/or a method which are proposed in FIG. 8.

The remote unit comprises a transmitter that transmits a capability report on supporting configuration of multiple BFD RS sets for a serving cell; and a receiver that receives a configuration including at least two NBI (new beam identification) RS sets and two BFI (beam failure indication) counters for the serving cell. The configuration may further include two BFD (beam failure detection) RS sets. Otherwise, the remote unit further comprises a processor that determines the two BFD RS sets.

When the serving cell is a SpCell and both BFI counters for the SpCell are larger than a configured maximum counter value, the processor initiates a random access procedure, wherein, when at least one new beam is identified from a first NBI RS set of the two NBI RS sets, a contention free random access procedure is initiated; and when no new beam is identified from the first NBI RS set, a contention based random access procedure is initiated. A BFR MAC CE may be included in a MAC PDU as part of the random access procedure, wherein the BFR MAC CE indicates whether new beam is identified from a second NBI RS set of the two NBI RS sets and a candidate RS ID corresponding to the new beam if the new beam is identified from the second NBI RS set.

The serving cell maybe a SpCell or a SCell. The transmitter further transmits a BFR MAC CE when only one of the two BFI counters for the SpCell is larger than a configured maximum counter value or when one or both of the two BFI counters for the SCell are larger than a configured maximum counter value. The BFR MAC CE may contain a S field to indicate whether beam failure is detected for one of the two BFD RS sets for the SpCell. In particular, S=1 indicates that beam failure is detected for only one BFD RS set for the SpCell, and S=0 indicates that beam failure is not detected for any BFD RS set for the SpCell. When S=1, the BFR MAC CE further contains a T field to indicate the beam failure is detected for which BFD RS set for the SpCell. If two BFD RS sets are configured for a SCell, the BFR MAC CE contains two bits, each of which indicates whether beam failure is detected for one BFD RS set for the SCell. If two BFD RS sets are configured for the SpCell, the BFR MAC CE contains two bits to replace the SP field, the S field and the T field, each of the two bits indicates whether beam failure is detected for one BFD RS set for the SpCell.

The gNB (i.e. base unit) includes a processor, a memory, and a transceiver. The processors implement a function, a process, and/or a method which are proposed in FIG. 9.

The base unit comprises a receiver that receives a capability report on supporting configuration of multiple BFD RS sets for a serving cell; and a transmitter that transmits a configuration including at least two NBI (new beam identification) RS sets and two BFI (beam failure indication) counters for the serving cell. The configuration may further include two BFD (beam failure detection) RS sets.

The receiver may further receive a BFR MAC CE included in a MAC PDU, wherein the BFR MAC CE indicates whether new beam is identified from a second NBI RS set of the two NBI RS sets and a candidate RS ID corresponding to the new beam if the new beam is identified from the second NBI RS set

The receiver may further receive a BFR MAC CE on an uplink resource. The BFR MAC CE may contain a S field to indicate whether beam failure is detected for one of the two BFD RS sets for the SpCell. In particular, S=1 indicates that beam failure is detected for only one BFD RS set for the SpCell, and S=0 indicates that beam failure is not detected for any BFD RS set for the SpCell. When S=1, the BFR MAC CE further contains a T field to indicate the beam failure is detected for which BFD RS set for the SpCell. The BFR MAC CE may further contain two bits, each of which indicates whether beam failure is detected for one BFD RS set for the SCell. The BFR MAC CE may further contain two bits to replace the SP field, the S field and the T field, each of the two bits indicates whether beam failure is detected for one BFD RS set for the SpCell.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method, comprising:
transmitting a capability report on supporting configuration of multiple beam failure detection reference signal (BFD RS) sets for a serving cell; and
receiving a configuration including at least two new beam identification reference signal (NBI RS) sets and two beam failure indication (BFI) counters for the serving cell.

2. The method of claim 1, wherein the configuration includes two BFD RS sets.

3. The method of claim 2, further comprising:
initiating a random access procedure based on the serving cell is a special cell (SpCell) and both BFI counters for the SpCell are larger than a configured maximum counter value.

4. The method of claim 3, wherein:
a beam failure recovery multiple access control control element (BFR MAC CE) is included in a MAC protocol data unit (PDU) as part of the random access procedure; and
the BFR MAC CE indicates whether the at least one new beam is identified from a second NBI RS set of the two NBI RS sets and a candidate RS identifier (ID) corresponding to the at least one new beam if the at least one new beam is identified from the second NBI RS set.

5. The method of claim 2, wherein:
the serving cell is a secondary cell (SCell), and the method further comprising:
transmitting a beam failure recovery multiple access control control element (BFR MAC CE) if one or both of the two BFI counters for the SCell are larger than a configured maximum counter value.

6. The method of claim 5, wherein, the BFR MAC CE contains a first bit field to indicate whether beam failure is detected for one of the two BFD RS sets for the SpCell.

7. The method of claim 6, wherein, a value S=1 of the first bit field indicates that the beam failure is detected for only one BFD RS set for the SpCell, and a value S=O of the first bit field indicates that the beam failure is not detected for any BFD RS set for the SpCell.

8. The method of claim 7, wherein, if the value S=1, the BFR MAC CE further contains a second bit field of a value T to that indicates the beam failure is detected for a first one of the BFD RS sets for the SpCell or a second one of the BFD RS sets for the SpCell.

9. The method of claim 5, wherein, if the two BFD RS sets are configured for the SCell, then the BFR MAC CE contains two bit fields, each of which indicates whether beam failure is detected for one BFD RS set for the SCell.

10. The method of claim 5, wherein, if the two BFD RS sets are configured for the SpCell, then the BFR MAC CE contains two bit fields, each of which indicates whether beam failure is detected for one BFD RS set for the SpCell.

11. (canceled)

12. An apparatus, comprising:
a processor; and
a memory coupled with the processor, the processor configured to cause the apparatus to:
transmit a capability report on supporting configuration of multiple beam failure detection reference signal (BFD RS) sets for a serving cell; and
receive a configuration including at least two new beam identification reference signal (NBI RS) sets and two beam failure indication (BFI) counters for the serving cell.

13. An apparatus, comprising:
a processor; and
a memory coupled with the processor, the processor configured to cause the apparatus to:
receive a capability report on supporting configuration of multiple beam failure detection reference signal (BFD RS) sets for a serving cell; and
transmit a configuration including at least two new beam identification reference signal (NBI RS) sets and two beam failure indication (BFI) counters for the serving cell.

14. The apparatus of claim 12, wherein the configuration includes two BFD RS sets.

15. The apparatus of claim 14, wherein the processor is configured to cause the apparatus to initiate a random access procedure based on the serving cell is a special cell (SpCell) and both BFI counters for the SpCell are larger than a configured maximum counter value.

16. The apparatus of claim 15, wherein:
a beam failure recovery multiple access control control element (BFR MAC CE) is included in a MAC protocol data unit (PDU) as part of the random access procedure; and
the BFR MAC CE indicates whether the at least one new beam is identified from a second NBI RS set of the two NBI RS sets and a candidate RS identifier (ID) corresponding to the at least one new beam if the at least one new beam is identified from the second NBI RS set.

17. The apparatus of claim 14, wherein:
the serving cell is a secondary cell (SCell); and
the processor is configured to cause the apparatus to transmit a beam failure recovery multiple access control control element (BFR MAC CE) if one or both of the two BFI counters for the SCell are larger than the configured maximum counter value.

18. The apparatus of claim 17, wherein the BFR MAC CE contains a first bit field to indicate whether beam failure is detected for one of the two BFD RS sets for the SpCell.

19. The apparatus of claim 18, wherein a value S=1 of the first bit field indicates that the beam failure is detected for only one BFD RS set for the SpCell, and a value S=O of the first bit field indicates that the beam failure is not detected for any BFD RS set for the SpCell.

20. The apparatus of claim 19, wherein if the value S=1, the BFR MAC CE further contains a second bit field of a value T that indicates the beam failure is detected for a first one of the BFD RS sets for the SpCell or a second one of the BFD RS sets for the SpCell.

21. The apparatus of claim 17, wherein at least one of:
if the two BFD RS sets are configured for the SCell, then the BFR MAC CE contains two bit fields, each of which indicates whether beam failure is detected for one BFD RS set for the SCell; or
if the two BFD RS sets are configured for the SpCell, then the BFR MAC CE contains the two bit fields, each of which indicates whether the beam failure is detected for the one BFD RS set for the SpCell.
